(19) United States
(12) Patent Application Publication
(10) Pub. No.: US 2010/0287802 A1
(43) Pub. Date: Nov. 18, 2010

(54) Informational message and scent signs

(76) Inventors: Juel Keith Harris, Chicago, IL (US); Elleniz Robinson-Harris, Chicago, IL (US)

Correspondence Address: THE INVENTORS NETWORK, INC., 332 ACADEMY STREET, CARNEGIE, PA, 15106, US

(21) Appl. No.: 12/454,144

(22) Filed: May 14, 2009

(51) Int. Cl. G09F 21/04

(52) U.S. Cl. 40/593

(57) ABSTRACT

An informational car freshener sign includes a cardboard sign having a front side and a back side, a written message setting forth rules and instructions in catchy and colorful wording to inform passengers in the rear seats of the driver's wishes with the written message accompanied by a pictorial representation such as a cartoon to enhance the impact and effectiveness of the sign, and the cardboard sign capable of giving off a particular scent to maintain the freshness of the interior environment. The sign is hung from the rear of the driver's seat or the front passenger seat, and the sign can be mounted in residential, commercial, and business establishments of all kinds. The sign can also be in the form of an air freshener calendar with the sheets for each month having different wording, cartoons, and scents.

### FIELD OF THE INVENTION

The present invention pertains to message signs and boards, and more particularly pertains to informational signs that combine drawings, indicia, and air freshener scents for use in automotive vehicles and other business settings for conveying necessary use, cleanliness, and sanitary requirements and conditions.

### BACKGROUND OF THE INVENTION

Signs and message boards are ubiquitous in contemporary life. In almost every public setting, be it industrial, commercial, or business settings, offices, restaurants, amusement parks, sports venues, public restrooms, traffic and highway settings, etc. signs of all shapes and sizes are used to convey messages regarding safety, directions, procedures, and operations of the respective facility. One place where signs advising and informing passengers and guests of the wishes of the individual owner do not generally exist is with regards to automotive vehicles. Normally the owner/operator/driver of the vehicle must remind his/her passengers and guests, especially passengers and guests in the back seat, on the wishes, guidelines, and instructions are for riding in the vehicle. Such obvious wishes and rules the driver may want passengers to follow is not to eat, drink or smoke in the vehicle. For passengers seated in the back seats this may require the driver to often turn around and remind the passengers of the driver's wishes and rules for riding in his or her vehicle. Such is usually the case when small children, pre-teens, and even on some occasions teenagers are riding in the back seats. This can be distracting for the driver and irritating for the passengers. Therefore, it would be desirable to have some type of message or sign prominently displayed to and for the back seat passengers to remind them in, preferably, a colorful and amusing way that includes both linguistic and visual representations on the message or sign. It would also be desirable that the message or sign be large enough to be easily viewable and readable and be mounted at the rear of the driver's front seat. Moreover, it would be desirable to not permanently mount the message or sign to the driver's seat so that should circumstances—or owners—of the vehicle change, a new message or sign can be mounted from the driver's seat. Furthermore, it would also be desirable to incorporate some type of scented air freshener with the message or sign for dispersing aromatic fragrances into the confined space of the automotive vehicle.

The prior art discloses a number of devices that include signs, messages, and air fresheners.

For example, the Viti patent (U.S. Pat. No. 4,909,438) discloses an air freshener dispenser that includes a cylindrical container having perforated sides so that a fragrance material contained therein can be exuded.

The Hoyt et al. patent (U.S. Pat. No. 5,304,358) discloses an air freshener device that includes a scented member held between two snap-locked layers and a picture or message card also held by the snap-locked layers and protected by a moisture barrier.

Sharma et al. (U.S. Pat. No. 5,800,897) discloses an air freshener composition that includes a fragrance composition incorporated into a fiber pad.

The Van Rees patent (U.S. Pat. No. 6,083,456) discloses a biodegradable air freshener that breaks down in the presence of water to minimize solid waste.

Nonetheless, despite the ingenuity of the above devices, there remains a need for a device or apparatus that combines a written message, colorful, eye-catching imagery, ad a freshener scent, and which is portable for mounting to the rear of the front car seat for informing rear passengers of the drivers conduct and behavior wishes and preferences. It is also desirable that the above device is adapted for use in public restrooms and facilities and that the above device also is adaptable as a calendar air freshener.

### SUMMARY OF THE INVENTION

The present invention comprehends a lightweight, portable device or apparatus that combines a sign or message with an air freshener scent to convey to passengers in an automotive vehicle or to users, guests and patrons of lavatory and restroom facilities, both private and public with the public facilities including restaurants, businesses, offices, industries, sports facilities and venues, amusement parks, etc. The sign is lightweight and portable and is mountable to the wall of the bathroom or public restroom behind the toilet, the rear of a car seat, or to any available post or pole in a public restroom. The mounting can be by any convenient method such as by brackets, clips, hangers or a rubber band.

Thus, the present invention includes a flat sign preferably of cardboard that can square or octagon-shaped. The sign includes a front side, a backside, a top and a bottom. The sign includes a number of mounting means located on the back side and the mounting means can include brackets, hangers, or a rubber band for hanging the sign from the rear of the front seat so that the wording on the sign is easily viewable and visible to passengers riding in the back seat. The wording informing the passengers of the driver's preferences should preferably be colorful and amusing, and can be accompanied by pictorial representations, such as illustrations and/or cartoons, for creating a better and more effective message.

In addition, an alternative design includes a calendar air freshener with twelve sheets, one for each month, and each month can include a unique and distinctive cartoon illustration and a witting, catchy, colorful phrase conveying the owner's wishes in a respectful and fun way. An air freshener scent is perfused or permeated on each sheet, and, more specifically, the scent can correspond to each month. For example, the sheet for December would have a pinecone or candy cane scent; the sheet for November would have a pumpkin pie scent; and the sheet for June would have some type of distinctive flower scent. The cardboard air freshener sign will also include a particular and distinctive scent perfused or permeated thereon so that the scent can be exuded throughout the particular area of use—whether the area is a vehicle interior, a home bathroom, or a public restroom facility. Because the cardboard freshener sign preferably has dimensions of 11 inches by 11 inches or 12 inches by 12 inches, more fragrance can be suffused on the sign for dispersal or exudation throughout the particular area, location, or space of use.

It is an objective of the present invention to provide an informational message and scent sign that includes written messages and is hung over the rear of the front car seat for viewing by individual's sitting in the rear seats.

It is another objective of the present invention to provide an informational message and scent sign wherein colorful, amusing pictorial displays or representations are combined with the written messages.

It is yet another objective of the present invention to provide an informational message and scent sign that alerts the passenger(s) in the vehicle to the vehicle's owner's rules and wishes such as to not eat or smoke.

It is still yet another objective of the present invention is to provide an informational message and scent sign that may be hung on a door knob in the home, hotel, restaurant, business establishment, public bathroom and restroom facility, amusement park, public sports venue, etc.

It is still yet a further objective of the present invention to provide an informational message and scent sign wherein the message can be targeted for a specific group or population such as students in a dormitory or employees, patients, and visitors to a hospital.

Still another objective of the present invention is to provide an informational message and scent sign that obviates the need of the driver/owner of the automotive vehicle to constantly remind the occupants of the back seat(s) of the rules for riding in his/her automotive vehicle.

Still yet another objective of the present invention is to provide an informational message and scent sign that include an air freshener scent that disperses a particular scent throughout the vehicle.

Yet another objective of the present invention is to provide an informational message and scent sign that combines colorful, funny wording with cartoon imagery and illustrations to better and more quickly capture the riders' attention.

A further objective of the present invention is to provide an informational message and scent sign wherein the scents dispersed can correspond to the setting, location, or season of use.

A still further objective of the present invention is to provide an informational message and scent sign in the configuration of a calendar air freshener with sheets for each month of the year and a different scent associated with each month.

These and other objects, features, and advantages will become apparent to those skilled in the art upon a perusal of the following detailed description read in conjunction with the accompanying drawing figures and appended claims.

### BRIEF DESCRIPTION OF DRAWING FIGURES

FIG. 1 is a perspective view of the informational message and scent sign of the present invention illustrating the sign mounted on the wall of restroom facility;

FIG. 2 is a front elevational view of the informational message and scent sign of the present invention illustrating a representative written message on the front of the sign;

FIG. 3 is a rear perspective view of the informational message and scent sign of the present invention illustrating one type of mounting means located on the back side of the sign;

FIG. 4 is a rear perspective view of the informational message and scent sign of the present invention illustrating a second type of mounting means located on the back side of the sign;

FIG. 5 is a front perspective view of the informational message and scent sign of the present invention showing the sign being mounted to a post or support pole;

FIG. 6 is a rear elevational view of the informational message and scent sign of the present invention illustrating the mounting of the sign to the front seat of the vehicle so that the front side of the sign is facing the rear passenger(s) seats; and

FIG. 7 is a perspective view of the informational message and scent sign of the present invention illustrating a square-shaped configuration for the sign.

### DETAILED DESCRIPTION OF THE PREFERRED EMBODIMENT

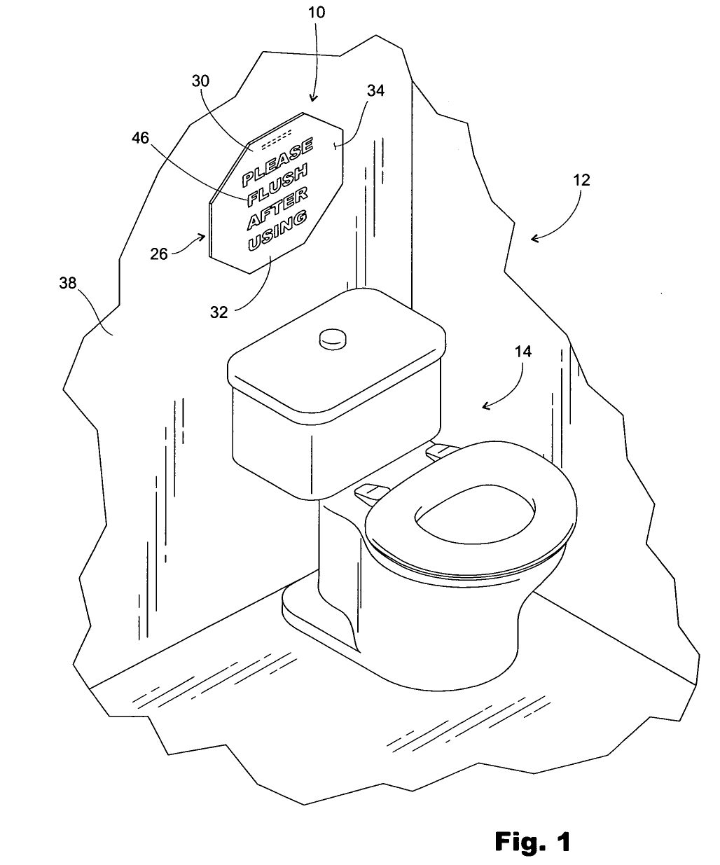

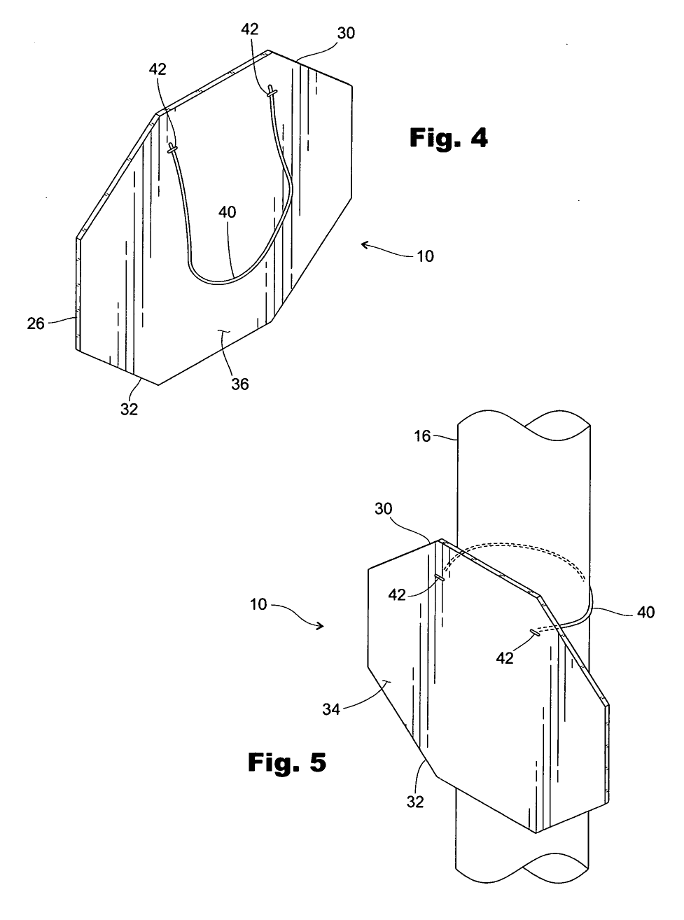

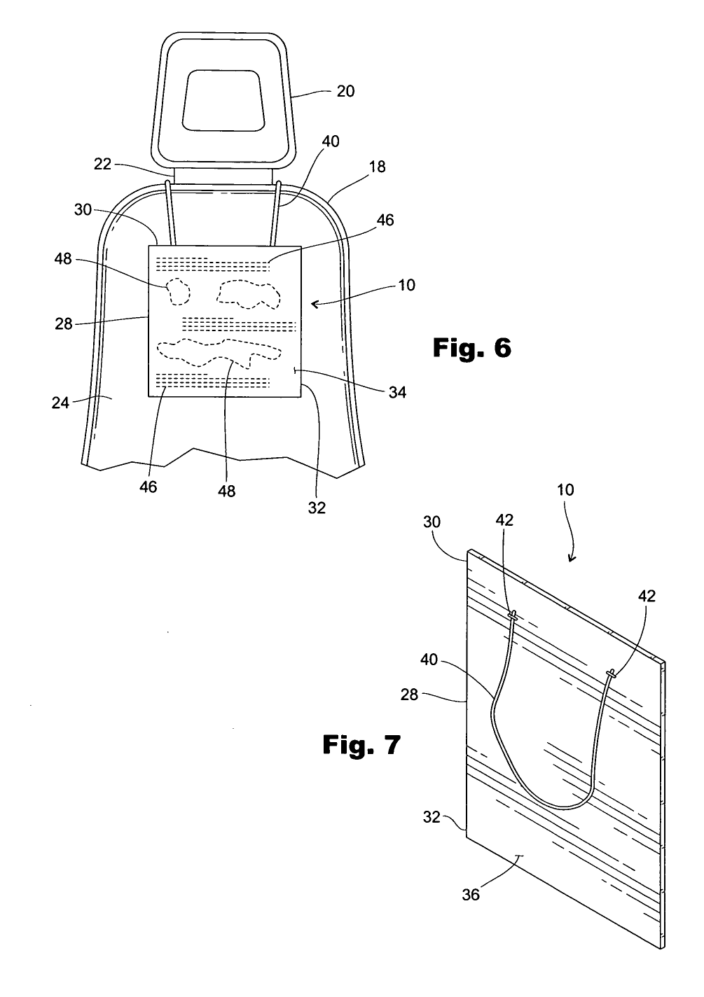

Illustrated in FIGS. 1-7 is a portable, lightweight car freshener sign 10 that conveys to individuals, guests, patrons, attendees, etc. the wishes and preferences of the driver/owner of the automotive vehicle or the rules and regulations of the commercial public business establishment. The informational vehicle air freshener sign 10 of the present invention, and which may be considered an oversize car air freshener, is primarily for display in the bathroom or restroom facility. The sign 10 can be hung on a doorknob or the sign 10 can be mounted on the wall of a bathroom above the toilet and easily visible as shown in FIG. 1. The bathroom 12 shown in FIG. 1 includes a toilet 14 and is representative of either a residential bathroom or a bathroom stall for a commercial establishment such as an office, a factory, a retail store or a restaurant. As shown in FIG. 5, the sign 10 is mounted to a post or pole 16. As shown in FIG. 6, the car freshener sign 10 is hung or suspended from a front car seat 18, and, more specifically, the sign 10 hung from the driver side front car seat 18. The front car seat 18 includes an adjustable headrest 20 that is mounted on supports 22, and the front car seat 18 includes a front side and a backside 24. The cardboard sign 10 is hung or suspended from the front car seat 18 so that the cardboard sign 10 hangs down alongside the backside 24 of the front car seat 18 where it is easily and readily visible to passengers, and especially children passengers, that are seated in the rear seats.

Illustrated in FIGS. 1-5 is the cardboard or plastic car freshener sign 10 having an octagonal-shaped configuration 26. FIGS. 6 and 7 illustrate the cardboard sign 10 having a square-shaped configuration 28. Preferable dimension for the sign 10 in either configuration are 11 inches by 11 inches and 12 inches by 12 inches. For either configuration 26 or 28 the cardboard sign 10 includes a top 30, a bottom 32, a front side 34, and an opposite backside 36. Various types of support or suspension means can be used to hang the sign 10 from the front driver side car seat 18, mount the sign 10 to the wall 38 directly behind the toilet 14, or attach the sign 10 to the pole or support 16 in, for example, a public restroom facility as specifically shown in FIG. 5. The support means shown in FIGS. 4, 6 and 7 includes a rubber band 40 attached to the backside 24 of the sign 10 with the ends of the rubber band 40 secured to the backside 36 by a clamp or fastener 42. Glue or any other suitable securement means can also be utilized. A bracket or picture hanger 44 is shown in FIG. 3 with the bracket 44 mounted to the backside 36 and adjacent the top 30 of the sign 10. With respect to the rubber band 40 shown in FIGS. 4, 6 and 7, the rubber band 40 can be placed about the head rest supports 22 thereby allowing the suspension of the sign 10 down and adjacent the backside 24 of the front driver side seat 18 or the rubber band 40 can placed or slipped onto and over the support or pole 16 of FIG. 5 for mounting the information and freshener sign 10 in a readily visible location.

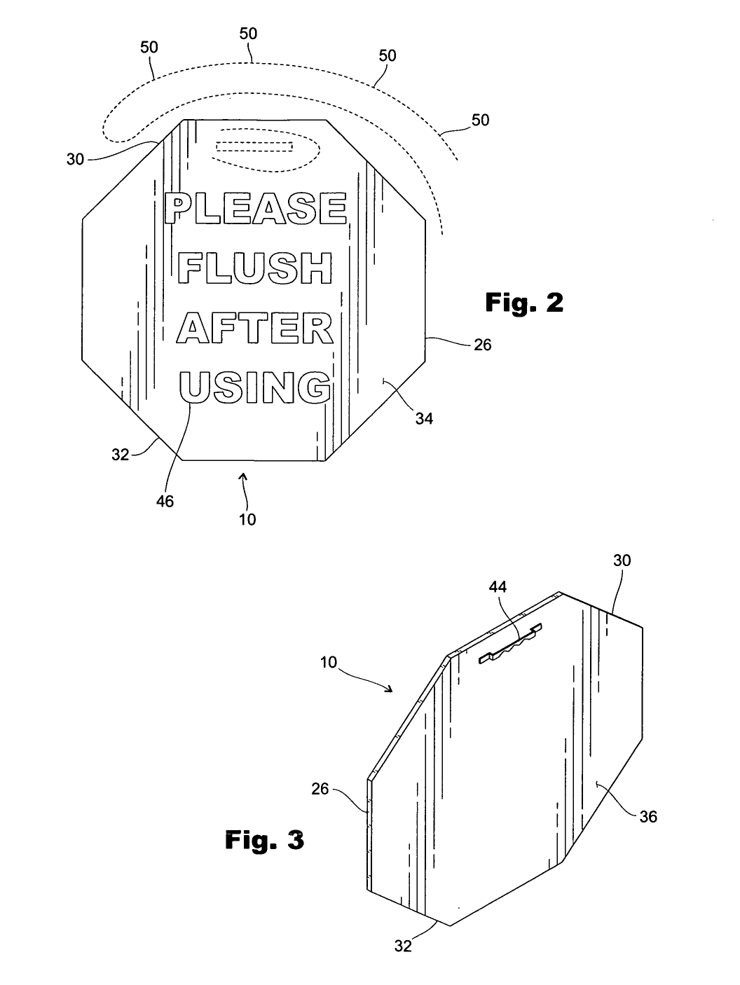

The front side 34 of the sign 10, as shown in FIGS. 1, 2 and 6, includes indicia 46 and graphical or pictorial representations 48 for conveying the wishes and preferences of the owner/driver of the vehicle when the sign 10 is used in the vehicle, and conveying the rules, regulations and guidelines of the residential, commercial and business establishment when the sign is placed in their respective restrooms. The indicia 46 may include written or printed messages stating and conveying any of a range of wishes, preferences, guidelines, rules, regulations, warnings, and instructions with representative one including “Please Don't Eat In My Car”, “Please Don't Smoke In My Car”, “Please Don't Litter In My Car” and “Please Flush After Using” as shown in FIGS. 1 and 2, etc.; when the sign is utilized is a public restroom representative written indicia may include “Please Flush After Using” and “Please Don't Throw Objects In The Toilet.” In order to enhance the visibility and impact of the indicia 46 conveying the written/printed message, graphical representations 48 in the form of animated cartoons, action figures, readily recognizable characters, etc. are included and such humorous pictorial representations 48 representing cartoons are shown in FIG. 6. Thus, the combination of colorful, funny, direct wording and animated cartoons enhances the visibility and effectiveness of the message being conveyed so that the driver of the vehicle, when the sign 10 is deployed in the vehicle, and especially when children are riding in the back seats, allows the driver to states his/her wishes, preferences, rules, etc. without having to constantly repeat his/her wishes and instructions.

In addition, as shown in FIG. 2, the sign 10 includes an air freshener scent 50 imbued or perfused throughout the cardboard sign 10 and capable of diffusion and dispersal throughout the area of use—whether the area is the interior of the automotive vehicle or the restroom or bathroom facility 12 as shown in FIG. 1. Because the sign 10 of the present invention is larger in size and dimension than standard car freshener signs, the scent or odor 50 given off emanates from a larger surface area and is thus more effective in freshening the vehicle interior or the bathroom or restroom facility 50.

Furthermore, another embodiment for the car freshener sign 10 includes a calendar air freshener with at least twelve sheets, one for each month of the year, with each month including a written message of wishes, preferences, rules, etc., in witty phraseology and each sheet being imbued with a scent unique for that month, time of the year, or season. For example, the sheet for the month of December can include a pinecone or candy cane scent; the sheet for the month of November can include a pumpkin pie scent; and the sheet for the month of June can include a flower scent.

As various changes, alterations, and variations can be made to the above constructions without departing from the spirit and scope of the invention, it is intended that all matter contained in the above description or shown in the accompanying drawings shall be interpreted as illustrative and not in any limiting sense.

We claim:

1. An informational and air freshener sign for suspension from the front car seat of the automotive vehicle to inform passengers of the wishes, preferences, and rules of the driver of the automotive vehicle, comprising:
a flat sign;
the sign includes a top, a bottom, a backside, and an opposite front side;
mounting means located on the backside for hanging the sign from the rear of the front car seat;
indicia located on the front side of the sign informing passengers of the wishes, preferences, and rules of the driver;
graphical representations located on the front side of the sign for enhancing the message conveyed by the indicia; and
a freshener scent suffused throughout the sign for dispersal throughout the interior of the automotive vehicle for freshening the automotive vehicle.

2. The informational and air freshener sign of claim 1 wherein the sign can include a square-shaped configuration.

3. The information and air freshener sign of claim 2 wherein the sign can include an octagonal configuration.

4. The information and air freshener sign of claim 3 wherein the graphical representations can include humorous cartoons.

5. The information and air freshener sign of claim 4 wherein the indicia can include funny and witty phrases.

6. The information and air freshener sign of claim 5 wherein the mounting means includes a rubber band secured to the backside of the sign.

7. The information and air freshener sign of claim 6 wherein the mounting means includes a bracket secured to the backside of the sign.

8. An information and air freshener sign for suspension from the front car seat of the automotive vehicle to inform passengers of the wishes, preferences, and rules of the driver of the automotive vehicle, comprising:
a flat cardboard sign;
the cardboard sign including a top, a bottom, a backside, and an opposite front side;
a rubber band mounted to the backside of the sign for wrapping around the front car seat so that the sign can be suspended therefrom;
indicia located on the front side of the sign for informing passengers of the wishes, preferences, and rules of the driver;
graphical representations located on the front side of the sign for enhancing the message conveyed by the indicia; and
a freshener scent suffused throughout the sign for diffusion throughout the interior of the automotive vehicle for freshening the automotive vehicle.
